(19) United States
(12) Patent Application Publication
(10) Pub. No.: US 2025/0270776 A1
(43) Pub. Date: Aug. 28, 2025

(54) RETRACTABLE BANNER ASSEMBLY

(71) Applicant: Andrew Eric Reiner, Park City, UT (US)

(72) Inventor: Andrew Eric Reiner, Park City, UT (US)

(21) Appl. No.: 18/587,296

(22) Filed: Feb. 26, 2024

(51) Int. Cl. E01F 13/02

(52) U.S. Cl. CPC E01F 13/028

(57) ABSTRACT

A retractable banner assembly and improved rollable fabric for use therein wherein the rollable fabric has improved dimensional stability to reduce fabric surface variances and which promotes the banner to smoothly roll and unroll and orient with sufficiently reduced unevenness on deployment, the assembly for use in residential, commercial, and public spaces, indoors and outdoors, to route persons and/or inhibit access to designated areas and effectively impart communications provided thereon.

### CROSS-REFERENCE TO RELATED APPLICATIONS

None

### TECHNICAL FIELD

This invention relates generally to a retractable banner assembly and improved rollable fabric for use therein, and more specifically to such an assembly wherein the rollable fabric has improved dimensional stability to reduce fabric surface variances and which promotes the banner to smoothly roll and unroll and orient with sufficiently reduced unevenness on deployment, the assembly for use in residential, commercial and public spaces, indoors and outdoors, to route persons and/or inhibit access to designated areas and/or effectively impart communications in an aesthetically pleasing manner.

### BACKGROUND OF THE INVENTION

Safety gates, particularly child and pet safety gates, are well known in the art for use in inhibiting or preventing access to residential areas such as kitchens, stairways, basements, garages, and the like, that may be unsafe or undesirable for children or pets. They typically comprise a plurality of cooperating and substantially rigid gate sections, comprised of wood, plastic, metal, and the like, and are generally horizontally extensible and retractable specifically within corresponding narrow entryways such as between doorjambs, opposed walls, balustrade uprights, and the like. They are also commonly provided on the ends thereof with compressible buffer stops comprising elastomeric material or other suitable spring mechanisms, which when compressed and then released, function to effectively set the corresponding gate or gate sections against displacement between the respective opposed fixed extremes defined by the narrow entryways. Additional safety latches have been used to further secure the relative positions of the corresponding gate sections and prevent inadvertent or undesired disengagement of the same following installation. To remove the gates after installation, the safety latches, if any, must first be disabled or released whereupon the buffer stops may be compressed (generally by applying lateral pressure to the same) to temporarily relieve applied tension on the opposed fixed extremes of the corresponding entryways. The rigid gate sections may then be sufficiently retracted (typically slid back) for the gate or gate system to be removed.

Variations of the above safety gates have included flexible fabric sections that are similarly extensible and retractable. However, the fabric sections, due to their physical characteristics and resulting lack of sufficient dimensional stability, exhibit physical fabric distortions including sagging, rippling, buckling, drooping, curling, and like fabric surface unevenness, which distortions not only prevent the gate from being smoothly rolled and unrolled, but impair the ability of the gate to impart communications on deployment due to resulting obstructions to user visibility. These fabric sections also comprise fiber structures and orientations that are unsuitable for printing, let alone higher fidelity printing on one or both sides thereof, as is typically desired to impart communications in commercial applications. Specifically, they fail to provide a sufficiently continuous surface having a sufficiently low texture which blocks sufficient visible light to promote high quality printing and display of communications. Such flexible safety gates have thus been found to be both functionally limited, if not inoperative, and aesthetically unappealing. While such banners may, despite these failings, be arguably suitable for their limited and specific intended use of blocking passage, they are neither designed nor intended to span greater distances such as, by way of example and not limitation, approximately 8 feet or more, with greater height, again by way of example and not limitation, approximately 2.5 feet or more, where the additional fabric required to do so and corresponding increased weight, would further exacerbate the existing fabric distortions. They are also not designed or intended to be interconnected, to define corresponding pathways, to guide or route persons or vehicles through such pathways, or to inhibit access to large, designated areas.

Safety gates have similarly been used in retail, warehouse, and other environments to temporarily prevent access to selected areas, sometimes to block or inhibit access through corresponding entryways such as shopping aisles, and the like, as may be defined, for example, by shelving and storage racks such as pallet rack systems and assemblies. Like the above-referenced child safety and pet gates, these gates, including variations having flexible fabric sections, due to their physical characteristics and resulting lack of sufficient dimensional stability, similarly exhibit physical fabric distortions including sagging, rippling, buckling, drooping, curling, and like unevenness, which distortions prevent the gate from being be smoothly extended and retracted, and impair its ability to effectively impart communications on deployment. The gates also fail to provide sufficiently smooth and continuous printing surfaces with sufficiently low texture and further fail to block sufficient visible light necessary to enable printing, let alone higher fidelity printing, on one or both sides thereof. Again, while such banners may, despite these failings, be arguably suitable for their limited and specific intended use of blocking passage, they are neither designed nor intended to span greater distances where the additional fabric required to do so, and corresponding increased weight would further exacerbate the existing fabric distortions. They are also not designed or intended to be interconnected, to define corresponding pathways, to guide or route persons or vehicles through such pathways, or to inhibit access to large, designated areas.

Stanchion top retractable belts have been used in public and private waiting areas and queues such as transportation centers (airports, train stations, bus stations, etc.), museums, event centers (theatres, concert halls, etc.), ticket offices, and the like, for specific traffic control purposes. A typical such stanchion top retractable belt generally comprises a small top cap affixed or affixable to an upright stanchion supported by a weighted or fixed base and having a narrow belt or tape, typically comprising a webbing material, that is extensible and retractable. While such stanchion top retractable belts may be suitable for the limited purposes to which they address, they are not suitable for the purpose of the present invention as heretofore described. Namely, as indicated above, these top mounted extensible belts are directed principally to guiding and routing persons along predetermined designated pathways. They structurally cannot and do not prohibit ingress or egress therefrom, as persons can readily duck under the corresponding tapes (and depending on the height of the combined stanchion and top cap, possibly step over the belt). As in the case of the above-referenced safety gates, stanchion top belts are similarly prone to inherent distortions, particularly when deployed across extended distances. Those skilled in the art will further recognize that webbing tends to be heavy which makes such belts prone to sagging when deployed more than a short distance. Those skilled in the art will still further recognize that a webbing surface does not print well, is susceptible to show through, and the limited printing space of such belts severely limits, if not precludes the ability to effectively deliver substantive communications, let alone aesthetically pleasing communications, whether printed or otherwise.

Various gates and barriers have similarly been proposed for use in preventing access to specified work, pedestrian, and recreation areas such as pools and the like and to define enclosures. As in the case of the above-referenced safety gates, even where flexible banner sections have been utilized, the sections remain prone to fabric distortions which contributes to unevenness of the banner section thus unacceptably hindering the smooth extension and retraction thereof and/or further prohibiting the effective delivery of aesthetically pleasing communications on deployment thus precluding even temporary use let alone reliable long-term use for even their intended purpose. Such gates are similarly typically not designed or intended to be interconnected to define corresponding pathways, to guide, or route persons or vehicles there through, to inhibit undesired ingress to or egress from such defined pathways or across extended lengths, or to effectively impart communications, let alone un-impaired, aesthetically pleasing communications such as higher fidelity printed messages on one or both sides thereof.

In summary, rollable fabrics, particularly when used as banners in retractable banner assemblies, generally operate poorly and heretofore very little innovation has been applied to improve either the fabric generally or the fabric as used in such an assembly specifically, both of which are a focus of the present invention. In the absence of such improvements, conventional retractable banner assemblies have been implemented to direct foot traffic but have been limited in height and length due to the referenced distortions and thus unsuitable to effectively impart communications such as the display of high-quality graphics and messaging. Vertically disposed retractable banner systems have been deployed with the intent to display aesthetically pleasing graphics, but lack of dimensional stability and resulting fabric distortions has similarly limited their use and effectiveness. Vertically and horizontally disposed rollable banner assemblies, wherein the banner, upon deployment, will be supported solely at its ends without interim support, as contemplated by the present invention, pose a particular challenge. Such an implementation generally presents competing mechanical property goals. Namely, the rollable fabric must be sufficiently flexible to be smoothly rolled and unrolled for stowage and deployment, yet sufficiently stiff to provide the needed dimensional stability to retain its shape across the space between the supports at the fabric's ends. More specifically, the fabric must have sufficient stiffness and resulting dimensional stability to resist deviations such as sagging, rippling, buckling, drooping, curling, and like unevenness when rolled and stowed, yet the fabric must remain sufficiently light to avoid distortions caused by the weight of the fabric. The fabric may also optionally provide a sufficiently smooth and continuous display surface with sufficiently low texture, and which blocks sufficient visible light for the intended application to enable the provision of higher fidelity printing on one or both sides thereof to impart aesthetically pleasing communications particularly when used for commercial applications.

Accordingly, there is a need for a retractable banner assembly and improved rollable fabric for use therein, having improved physical characteristics, including sufficient dimensional stability, to promote the smooth rolling and unrolling of the fabric, namely spooling on a roll for wrapping many times around itself and the spool, and subsequent unfurling or unwrapping of the same in whole or in part for deployment, and which upon such deployment has reduced distortions.

Still further, there is a need for such a retractable banner assembly wherein the improved fabric is both aesthetically pleasing and functionally operative to effectively impart aesthetically pleasing communications with no or minimal and thus acceptable visible obstruction to users.

Still further, there is a need for such a retractable banner assembly wherein the improved fabric has a sufficiently smooth and continuous printing surface which blocks sufficient visible light as necessary to promote high quality printing of communications thereon.

Still further, there is a need for such a retractable banner assembly wherein the improved fabric imparts the aforementioned dimensional stability within certain weight parameters.

Yet still further, there is a need for such a retractable banner assembly that may be implemented alone or in combination with other such assemblies to defining one or more pathways in residential, commercial, and/or public spaces, indoors and outdoors, to route persons through such pathways, and/or to block or otherwise inhibit access to designated areas.

### SUMMARY OF THE INVENTION

It is a principal object of the present invention to provide a retractable banner assembly and improved rollable fabric for use therein, wherein the fabric has improved physical characteristics, including sufficient dimensional stability, to sufficiently reduce unevenness of the fabric to promote the fabric to smoothly roll and subsequently unroll for deployment and to further promote the fabric to orient with sufficiently reduced distortions such as sagging, rippling, buckling, drooping, curling, and like unevenness, upon such deployment. For clarity, it should be noted that distortions, fabric distortions, surface distortions, and unevenness are all used interchangeably herein.

It is a further object of the present invention to provide such a retractable banner assembly wherein the improved rollable fabric is aesthetically pleasing and effectively imparts communications to users upon deployment.

It is a further object of the present invention to provide such a retractable banner assembly wherein the improved rollable fabric has a sufficiently continuous printing surface that blocks sufficient visible light to promote higher quality printing of communications thereon.

It is a further an object of the present invention to provide such a retractable banner assembly that may be readily interconnected with one or more like assemblies, or other fixed or portable end points, to define corresponding pathways, to guide or route persons or vehicles through such pathways, and/or to inhibit access to designated areas.

In carrying out these and other objects, features, and advantages of the present invention, there is provided a retractable banner assembly having a rollable fabric affixed directly or indirectly to a rotatable elongate mounting rod, the fabric having sufficiently high flexural rigidity and sufficiently low areal density to impart the necessary dimensional stability of the fabric to promote the fabric to smoothly roll and unroll and orient substantially flat on deployment.

For background purposes, those skilled in the art will recognize, that fibers as may be used in a rollable fabric, generally fall into 3 categories: (1) animal, (2) plant, and (3) synthetic. Wool, cotton, and polyester are representative corresponding examples of each of the foregoing. Synthetic fibers may further be classified as staple (also known as cut to length fibers), tow (a continuous rope of fibers consisting of many filaments loosely joined side-to-side, and filament (a continuous strand consisting of 1 or more filaments). Yarn is typically created by “spinning” fibers. Knit fabrics may be formed through weft or warp knitting processes. The former often involves a single yarn or thread that is repeatedly looped with itself or with other previously looped yarns but can involve more. The latter involves many individual yarns or threads that are interlaced. Woven fabrics are created using several longitudinal (machine direction) yarns (interchangeably referred to as warp yarns) and wefts, or latitudinal (cross-machine direction) yarns (also interchangeably referred to as filling yarns). Multiple yarns interlace and thus cross each other, typically at right angles, like a basket. Non-woven fabrics, in contrast, generally comprise cut to length or continuous fibers that have been bonded together using any suitable manufacturing process including any combination of heat, chemical, and/or mechanical treatment and without weaving or knitting.

Fabrics have physical and mechanical properties, including weight, stiffness (interchangeably referred to as flexural rigidity), bending length, crease recovery, thread density for knit fabrics, ends, or picks per unit length for woven fabrics, opacity, visible transmittance, cover factor, show-through, and surface topography. These properties may be interrelated and help to describe a fabric's performance characteristics as discussed in further detail below as relevant to the present invention.

Weight, more specifically areal density, when used in reference to fabrics and referenced herein according to the invention, is a two-dimensional measure of the mass of a fabric per unit area, generally expressed in grams per square meter or ounces per square yard. In the context of a fabric, areal density is an important factor that is typically interrelated to other physical properties of the fabric including strength, durability, thickness, and stiffness. Areal density is affected by many factors including the method and material of construction which may include among other variables, different fiber types, yarn counts, weave or knit structures, substrates, and substrate assemblies, and finishing processes. The areal density of a fabric is typically calculated by weighing an area of the fabric and then dividing the weight by the area. Areal density may be used to compare fabrics or elements of different constructions and fiber types.

Fabric stiffness is related to a fabric's flexural properties, namely a fabric's tendency to bend or flex under a specified force or resist the same. These flexural properties can be assessed by measurement of the amount of deflection or bending generally, the specific force required to bend the fabric to a certain degree, as well as the fabric's ability to recover its shape after being so bent or flexed. Stiffness may be affected by many factors. Adding material, which adds areal density, may result in the fabric being more resistant to bending and thus having greater stiffness. Conversely, the additional weight, may result in the fabric actually being more susceptible to deflection as it bends under its own weight. As those skilled in the art will recognize, stiffness may also be reported in terms of flexural rigidity, which is measured variously in microJoules meters (μJ-m), milligram centimeters (mg-cm), microNewton meters (μN-m), or TABER Stiffness Units, to name a few, using a suitable instrument and methodology. In each case, a force required to deflect a fabric sample in a specific direction to a specified angle is measured and a flexural rigidity value (i.e., stiffness) of the fabric is calculated from the results. In the alternate, a fabric sample is subjected to a specified force, and the resulting distance or angle of deflection is measured. The flexural rigidity value of the fabric is then calculated based on the force applied and the measured distance or angle of deflection.

“Bending length” is an important characteristic of a fabric that governs its applications. Fabrics with high bending length tend to be stiffer and lack good drape and flexibility which is desirable in some applications but not the current innovation. Bending length is typically defined as half the falling length when a fabric falls under its own weight beyond a cantilever point to a specific angle and is typically measured in centimeters. There are many factors that impact bending length, primarily including flexural rigidity and areal density as referenced above. Some factors that affect flexural rigidity and areal density include, for example, yarn properties, weaving parameters, and processing parameters.

A fabric's ability to return to its original shape after being subjected to a bending or creasing force during use can also be measured to assess the flexural properties of a fabric and is referred to herein as “crease recovery”. Fabrics with adequate crease recovery are able to maintain an aesthetically pleasing appearance and continue to function properly for their intended use after being subjected to such forces. Again, as those skilled in the art will recognize, crease recovery is measured in degrees of angle recovery ranging from 0 degrees indicating no recovery to 180 degrees corresponding to full recovery, using a suitable instrument and test. In this test, a load is applied to a bent specimen while the specimen is maintained in a creased form for a specified time. After the time expires, the load and thus the force are removed, and the specimen is given a set period of time to “recover”. After the recovery time expires, the crease angle is measured.

Ends per unit length and picks per unit length are measurements used to describe the structure of a woven fabric in terms of the number of warp yarns (ends) and weft yarns (picks) per applicable linear measurement unit of the fabric. For example, in the imperial system, ends or picks are counted per inch and appropriately termed ends per inch (EPI) and picks per inch (PPI) as applicable. Conversely, in the metric system, ends and picks are counted per centimeter and termed ends per centimeter (EPC) and picks per centimeter (PPC). As the number of fibers used in the construction of a fabric increases in both the warp and weft directions, the stiffness of the fabric in the weft direction tends to increase accordingly and generally the areal density as well. However, increases in number of fibers may, depending on the configuration and materials used, cause the stiffness in the warp direction to decrease.

Opacity is a measure of how much visible light is blocked by a specific fabric sample. Opacity is typically expressed as a percentage between 0% and 100% where a higher value indicates greater opacity (i.e., greater blocking of light). A fabric with high opacity, or more appropriately a high opacity value, will block more light and be less transparent than a fabric with a lower opacity value. A fabric that blocks all light is considered fully opaque. Conversely, a fabric that allows all light to pass through without scattering or distorting such that objects on the other side are clearly visible, is considered fully transparent. A fabric that allows some degree of light transmission but is not fully transparent and scatters light and causes it to be diffused so that objects on the other side are not clearly visible is deemed translucent. Visible transmittance, in contrast to opacity, is a measure of the amount of visible light that is transmitted through a fabric sample. It can similarly be expressed as a percentage between 0% and 100%, where a higher value indicates greater light transmission. A fabric with a high visible transmittance will allow greater light to pass through it, while a fabric with low visible transmittance will block greater light. For the purposes of the current invention in which the fabric banner is intended to be printed on at least one side and suitable to be viewable from both sides, the opacity must be sufficient to block visibility of the image printed on one side when viewing from the other side. Printable banners are used inside and outside, in direct light and in ambient light, and must have suitable opacity for these different lighting conditions.

Cover factor is similarly a measurement that may be used to describe the structure of a woven fabric, but in terms of the degree of openness or porosity, and more specifically, the proportion of closed space to total fabric surface area. It thus quantifies the degree to which a fabric conceals or otherwise “covers” the surface beneath it. This value is affected by several factors including, in the case of woven fabrics, ends or picks per unit length, as referenced above, as well as the types of yarn used, each yarn's thickness, the applicable weave pattern, and finishing techniques employed. In general, woven fabrics with a higher value of ends per unit length and/or higher value of picks per unit length, as applicable, and non-woven fabrics having a higher thread density, in either or both directions, will tend to have a tighter weave and thus typically have greater stiffness, and opacity, and a higher cover factor collectively making them less prone to distortions and thus having reduced unevenness particularly across greater distances and less susceptible to show-through. However higher value of ends per unit length, picks per unit length, and thread density, also tends to add areal density which may increase distortions, particularly across greater distances. Conversely, fabrics with a lower value ends or picks per unit length (or thread density) in either or both directions will tend to have a looser weave and thus typically lower areal density, stiffness, and opacity, and lower cover factor making them more prone to distortions, again unevenness particularly across greater distances, and more susceptible to show through. These fabrics may be less suitable for high-quality printing.

Show-through as will be referred to herein describes the phenomenon where a color or pattern on one side of a fabric is visible from the other side. This typically occurs when light passes through the fabric and reflects off the surface or the fibers, creating a faint impression of the image or pattern on the other side. This is generally a result of the fabric having insufficient opacity (or conversely too much visible transmittance) and this may result from factors including, but not limited to, insufficient ends per unit length, insufficient picks per unit length, in one or both directions, insufficient thread density, too low a cover factor value, inappropriate construction or finishing operations, and/or insufficient fabric thickness, as well as use of a too lightly colored fabric for the application. As those skilled in the art will recognize, fabrics having the same areal density may nonetheless exhibit different degrees of show-through and/or stiffness depending on all of the foregoing.

Surface topography, interchangeably referred to as surface texture, finish, or roughness, is generally understood as the local deviation of a surface from a substantially flat plane. It is measured using a contact or non-contact-based instrument such as a stylus-based instrument commonly known as a profilometer or a laser scanner or the like (also called a non-contact profilometer), respectively. The greater the deviations, typically measured in micrometers or microinches, the “rougher” the surface. Surface topography is highly dependent on both the structure of a fabric and the process of manufacturing it with acceptable ranges of roughness dependent on the specific application including how the fabric will be implemented, whether it will be printed, and if so, where and through what process.

Against this background, dimensional stability may be principally achieved in accordance with the present invention, by providing a rollable fabric for use in a retractable banner assembly wherein the fabric has sufficiently high flexural rigidity and sufficiently low areal density to reduce fabric surface variances and to promote the fabric to smoothly roll and unroll and orient substantially flat on deployment. To promote higher quality printing of aesthetically pleasing communications, the rollable fabric may optionally further have at least one display surface that is sufficiently smooth and continuous for messages to be effectively printed thereon with no or acceptable show through and/or cover factor. The rollable fabric may be implemented in a retractable banner assembly and further in combination with other rollable fabrics and/or banner assemblies or end points, to define one or more pathways in residential, commercial, and public spaces, indoors and outdoors, route persons or vehicles through such pathways, and block or otherwise inhibit access to designated areas.

These and other objects, features, and advantages of the present invention will be more readily apparent by reference to the following brief description of the drawings and best modes for carrying out the invention. It is to be understood that the drawings and description are solely for exemplary purposes and are not intended to limit, and do not limit, the scope of the invention as set forth in the accompanying claims.

### BRIEF DESCRIPTION OF DRAWINGS

FIG. 1 is a perspective diagram of one preferred embodiment of the retractable banner assembly and improved rollable fabric of the present invention shown with the fabric unrolled and partially extended from a spool for cutting or deployment;

FIG. 2 is a schematic illustrating a preferred fabric stiffness testing method used in accordance with the present invention.

FIG. 3 is a perspective diagram of one preferred but not required embodiment of the improved rollable fabric of the present invention wherein the fabric includes a substrate comprising a plurality of stiffening fibers which may be monofilament yarns.

FIG. 4 is a perspective diagram of an additional preferred but not required embodiment of the improved rollable fabric of the present invention wherein the fabric comprises an extruded substrate.

FIG. 5 is a perspective diagram of yet an additional preferred but not required embodiment of the improved rollable fabric of the present invention wherein the fabric comprises a non-woven substrate assembly; and

FIG. 6 is a perspective diagram of still further an alternative embodiment of the improved rollable fabric of the present invention wherein the fabric comprises a laid-scrim substrate.

### DETAILED DESCRIPTION OF THE INVENTION

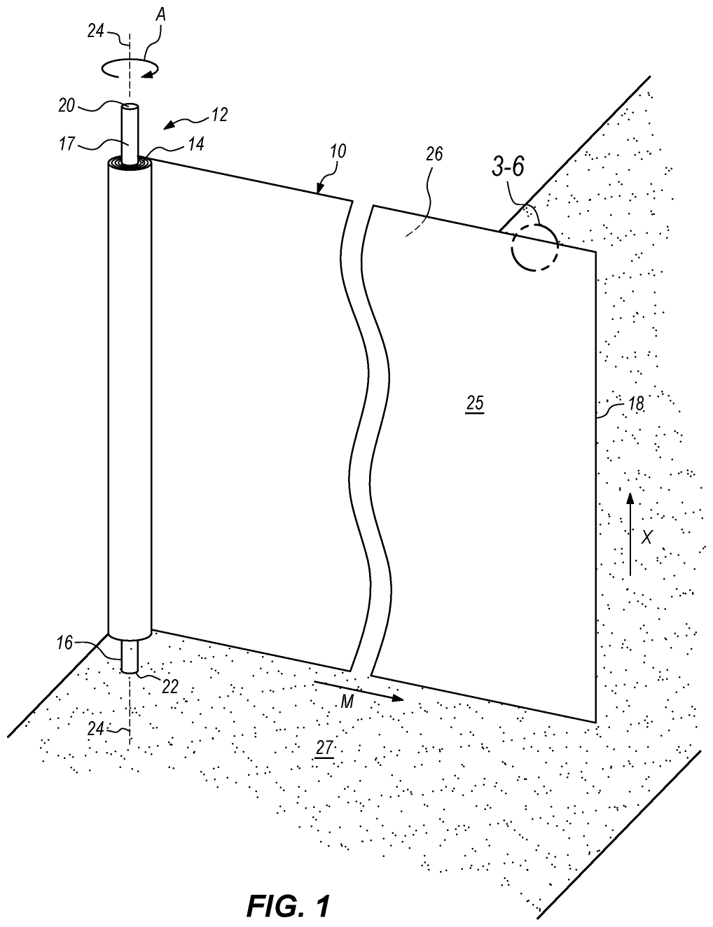

With reference to FIG. 1 of the drawings, there is provided a perspective diagram of the improved rollable fabric 10 of the present invention. As indicated above, conventional rollable fabrics are prone to visible physical distortions, such as sagging, rippling, buckling, drooping, curling, and the like, when unrolled, deployed, and re-rolled. These distortions, which are generally multi-dimensional as caused by opposing forces such as gravity, air turbulence, tension variations, and the like, individually and collectively create distortions in the corresponding surfaces of the fabric banners, namely unevenness, which distortions are aesthetically unappealing, and when implemented in a banner assembly, in turn hinder the smooth unrolling, deployment and rolling of the same, even across the relatively short distances of some of their intended uses, which distortions impair the visibility of messages that may be printed or otherwise displayed thereon, and often degrade the printed messages as well. Such fabrics may also have insufficient opacity to prevent show through of the aforementioned messages, particularly in the case of higher-fidelity printing, on one display side thereof, let alone both sides, which in turn diminishes their aesthetics upon deployment. In keeping with the invention, fabric 10 has an improved material structure and orientation with sufficiently high stiffness in at least one direction, and sufficiently low areal density, to provide sufficient dimensional stability to counteract distortions of sagging, rippling, buckling, curling, drooping and the like to facilitate an aesthetically appealing fabric regardless how fabric 10 is supported, hung, or otherwise used. When optionally implemented in a banner assembly, the improved material structure further facilitates smooth rolling and unrolling/unfurling of fabric 10 and improves the ability of fabric 10 to remain substantially flat upon deployment.

Still referring to FIG. 1, fabric 10 is accordingly shown incorporated in one exemplary, but not required, embodiment as part of a retractable banner assembly 12 wherein fabric 10 may be unrolled or “unfurled” or otherwise dispensed from a rotatable core or spool 16 (also referred to as an elongate rotatable mounting rod) in the M direction for cutting or use as a banner or any other suitable use. Depending on the application, assembly 12 may optionally include, but is not required to include a housing to enclose fabric 10 and spool 16 in whole or in part, any suitable winding mechanism (e.g., a hand crank), and/or any suitable biasing means (e.g., spring, or similar mechanical or electromechanical mechanism) operative to apply a biasing force on spool 16 and thus fabric 10. In such case, a threshold pull force will be required to unroll fabric 10 from spool 16 for use or deployment. Such biasing means may further cause fabric 10 to roll upon release in part of the applied pull force, and preferably, but not necessarily, return to a fully rolled storage position upon full release of the applied pull force. Optional assembly 12, may be fixed, mountable, portable, self-supporting, anchorless, stanchion based, or incorporate any other form and structure of attachment or combination thereof.

Rollable fabric 10 in assembly 12 of FIG. 1 includes a trailing edge 14 to be coupled directly or indirectly to and for winding or rolling about a rotatable center spool or core 16. Fabric 10 further includes a leading edge 18 that is unrollable and thus extensible from spool 16 upon and in response to a pull force as indicated above for deployment, and thereafter rollable and thus retractable toward spool 16. In one preferred, but not required embodiment, fabric 10 may optionally extend greater than approximately 8 feet in length in the M direction and/or have a leading and/or trailing edge greater than approximately 2.5 feet in height in the X direction and be extensible upon and in response to a pull force or forces individually and/or collectively greater than approximately 8 pounds. In keeping with the invention, spool 16 may have any suitable length, shape, thickness, and corresponding profile depending on the desired application and functionality and may comprise any suitable material and structure manufactured through any suitable process. By way of example only and not limitation, spool 16 may therefore comprise as shown, a narrow, elongated, extruded aluminum tube that is at least partially hollow, having a relatively uniform internal cylindrical cross-section, and defined by opposing top and bottom flat ends 20 and 22 respectively. Alternatively, spool 16 may comprise in any suitable combination, a thicker, shorter, tube, rod or dowel having a curved or otherwise irregular shaped core with a non-uniform internal cross-section in whole or in part that may be solid and defined by rounded, curved, or slanted ends or any variation thereof. Accordingly, it is understood that the exterior and visible surface 17 of spool 16 and respective top and bottom ends 20 and 22 may be styled to user preferences in each case independently of the internal cross section of spool 16 without departing from the scope of the invention herein.

Still referring to FIG. 1, spool 16 may be comprised of any suitable original or recycled material again including by way of example and not limitation, any metal, polymer, paper based, ceramic, clay, plastic, wood, or the like, or any combination thereof included any suitable composite material comprising any of the foregoing or additional material or materials. In keeping with the invention, the exterior surface 17 of spool 16 may be smooth as shown or textured in whole or in part, including any etching or deposition of material including coating and/or laminating with any suitable material as desired for protection, ornamentation, and/or to enhance its performance. Banner 10 and specifically trailing edge 14 thereof may, further be coupled, including removably coupled, directly, or indirectly, internally, or externally, to spool 16 in any suitable manner including through one or more adhesives, fasteners, or intermediate linking structures or components. The coupling may be permanent or temporary. By way of example only, and not limitation, an additional dowel, not shown, may therefore be provided in mechanical communication with trailing edge 14 for placement within or about one or more internal or external channels or raised edges, also not shown, of spool 16 that may be formed thereon at any suitable point thereof through extrusion, coating, cutting, or the like. Depending on the intended use of fabric 10, it may be dispensed from spool 16 to then be sized, cut, or otherwise formed for use as a banner in any way that a banner may be used.

Upon unrolling and extension for deployment, whether in a substantially horizontal orientation as shown in FIG. 1 or a vertical orientation, not shown, leading edge 18 of fabric 10 unrolls and thus extends from spool 16 in a direction designated by reference letter M, also commonly referred to as the machine or warp direction. Depending on the manufacturing approach however, the M direction shown for use of the fabric can also be the fill or cross-machine direction. Regardless, direction M shows the direction of unrolling of the fabric and is opposite the direction of rolling or winding on spool 16 and is also substantially perpendicular to a primary or center axis of rotation 24 of spool 16. Accordingly, when banner 10 is unrolled in direction M, spool 16 in turn rotates about center axis 24 in the direction designated by reference letter A. In the exemplary embodiment shown where fabric 10 is wound ‘under’ spool 16, direction A will accordingly be clockwise. Conversely, if banner 10 is wound ‘over’ spool 16, not shown, direction A will be counterclockwise. When rolled and thus retracted, whether to a new deployment position or following completion of deployment and return to a starting position wherein banner 10 is substantially or completely retracted, leading edge 18 similarly rolls back toward spool 16 in the opposite direction of reference letter M and is wound onto spool 16 again about axis of rotation 24 as spool 16 rotates in the opposite direction from unwinding (i.e., counter-clockwise if originally wound under spool 16 and clockwise if originally wound over spool 16).

As referenced above, rollable fabric 10 minimally has a material structure and orientation with sufficiently high stiffness in at least one direction, and sufficiently low areal density, to provide sufficient dimensional stability to counteract the referenced distortions of sagging, rippling, buckling, curling, drooping and the like to facilitate an aesthetically appealing fabric and when implemented in a retractable banner assembly, to further facilitate smooth rolling and unrolling and improve the ability of the fabric to remain substantially flat upon deployment.

As indicated above, fabric stiffness is related to a fabric's flexural properties, namely a fabric's resistance to bend or flex under a specified force as measured using a suitable stiffness test. Cantilever testing is one commonly accepted method for determining the stiffness of fabrics and will be referenced herein for purposes of the present invention. In cantilever testing a fabric is pushed out beyond the edge of a horizontal platform edge so that it flexes downward under its own weight. The length beyond the platform required for the fabric to flex down to a pre-determined angle is measured. The length of overhang of the fabric, or the corresponding “bending length,” which is ½ the overhang length, can be used in place of areal density and flexural rigidity to define the required stiffness and areal density fabric properties of the current invention. However, that length along with the weight of the fabric can also be used calculate the stiffness/flexural rigidity of the fabric. Three cantilever test methods for fabric with international acceptance are: ISO 9073-7:1995-9073, ASTM3260-18 and ASTM D1388. ISO 9073-7:1995-9073 applies to nonwoven fabrics. The bending length is determined, and then flexural rigidity in millinewton centimeters is calculated using a formula which is provided in the standard. ASTM3260-18 applies to medical textiles such as surgical mesh, films, and membranes. Bending length is measured and then flexural rigidity is calculated in microJoules or microNewton meters. ASTM D1388 applies to many fabrics including woven fabrics, air bag fabrics, blankets, napped fabrics, knitted fabrics, layered fabrics, pile fabrics. The fabrics may be untreated, heavily sized, coated, resin-treated, or otherwise treated. Bending length is measured and then flexural rigidity is again calculated in microjoules or micronewton meters using a formula which is provided in the standard.

In these and other similar cantilever tests, the stiffness of the fabric is calculated based on its bending length and weight per unit area. Using the acceleration due to gravity, the calculation measures the work done by gravity to bend the fabric per unit length of the fabric. The resulting quantity is often referred to as “stiffness,” “flexural rigidity,” or “bending modulus”. The units of measurement used for this quantity are typically some form of energy (or work) per unit length, such as microjoules or micronewton meters. These units of measure are appropriate for this context; however, it is important to note that this fabric “stiffness” or “flexural rigidity” is a somewhat context specific quantity. These fabric stiffness testing standards involve a specific testing protocol and related calculation. The calculation essentially measures the work done by gravity to bend the fabric, per unit length of the fabric, which is why the units are typically some form of energy (or work) per unit length, like millinewton-meters (mN·m) or millijoules per meter (mJ/m). It is not the same as the more general concept of flexural rigidity (D=E*I) used in engineering mechanics, which has units of force times length squared (e.g., N·m²), taking into account not just its modulus of elasticity (E, a measure of stiffness under tensile or compressive stress), but also its moment of inertia (which depends on its cross-sectional shape and size).

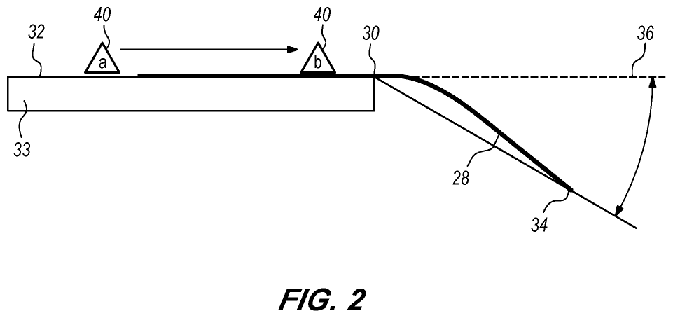

Of the fabric stiffness testing standards, ASTM D1388 has broad application and is well suited by way of example but not limitation for the determination of fabric stiffness related to the invention disclosed herein. ASTM D1388 proscribes two alternate methods of calculating stiffness which are, Option A, the “cantilever” test, and Option B, the “heart loop” test. Option A, which is better suited but not required for the present invention, is performed in summary as follows with reference to FIG. 2 of the drawings. The standard expressly recites: “Option A, Cantilever Test-A specimen 28 is slid at a specified rate in a direction parallel to its long dimension, until its leading edge or touch point 34 projects from the vertical edge or fulcrum 30 of a horizontal surface 32, which is typically a stationary table 33 with a linear scale. The length of the overhang is measured when the touch point designated by reference numeral 34 of the specimen 28 is depressed under its own mass to the point where a horizontal line 36 joining the top to the edge 30 of the platform makes a 0.724 rad (41.5°) angle with the horizontal. From this measured length, the bending length and flexural rigidity are calculated.” Note that during the process, a weight 40 moves with the fabric from position “a” to position “b”. As those skilled in the art will recognize, weight 40 is used to stabilize the testing sample and keep the fabric flat where it is not beyond the edge 30, beyond which the fabric is cantilevered. The steps in summary are as follows as recited in the standard:
1. Sample Preparation: A strip of fabric 25 mm×200 mm+/−1 mm (1×8 in +/−0.04 in.) is cut and then conditioned to temperature, pressure, and humidity in accordance with D1776. (a standard atmosphere (typically 21° C. and 65% relative humidity).
2. Preparation of Test Apparatus: The test apparatus is set on a table or bench and confirmed to be level. The bend angle indicator is set to 41.5 degrees.
3. Mounting the Sample: The fabric strip is placed on the horizontal top surface 32 of the tester so that it can be moved lengthwise beyond the surface edge.
4. Measuring the Bending Length: The fabric strip is moved forward so that it bends under its own weight until its leading edge 34 first contacts the bend angle indicator indicating that the fabric's leading edge has reached a point which is 41.5 degrees below the horizontal top surface of the tester. The overhang length is then measured. The bending length is calculated as ½ the length of the overhang length of the strip at the point when the leading edge of the fabric reaches a point on a plain which is 41.5° below the horizontal top surface. This can be measured directly using any suitable device.
5. Calculating the Stiffness: The stiffness or flexural rigidity of the fabric is calculated based on the bending length, the weight per unit area of the fabric, and the acceleration due to gravity. The standard provides a specific formula for this calculation. The result is reported in units of microNewton-meters (mN·m) but could also be calculated using a different formula to get microJoule meters.
6. Repeat Measurements: The test is usually repeated several times (the standard recommends at least 20 times for each fabric), and the results are averaged to obtain a representative stiffness value.

Stiffness can also be determined in TABER Stiffness Units using a TABER Stiffness Tester model 150-B or 150-E or other similar operating model as may be later introduced by TABER or the like to perform the same function. The TABER Stiffness Tester operates by holding a fabric sample of specified dimensions vertically and then applying an increasing force (“torque”) until an established distance or angle of deflection is achieved from which TABER Stiffness Units are determined. More specifically, the instrument utilizes a two-direction pendulum-type weighing system comprising clamp jaws with lower faces positioned on the pendulum exactly on the center of rotation to evaluate material stiffness and flexural strength. This ensures a constant deflection angle for accurate and repeatable results. Both jaws of the specimen clamp are adjustable so that the test specimen can be positioned precisely in the center regardless of the material thickness. In operation, force is applied to the lower end of the specimen by a pair of rollers that are attached to a driving disc positioned directly behind the pendulum. The rollers push against the test specimen and deflect it from its initial vertical position. The test point reading occurs when a pendulum mark aligns with the appropriate driving disc mark (7.5 degrees or 15 degrees), which points to the stiffness reading on a dial point. The final reading depends on the range in which the test is being conducted and the selected scaling factor. The instrument outputs the moment load applied to the test specimen in TABER Stiffness Units (g·cm) wherein 1 TABER Stiffness Unit is equivalent to approximately 98 micro newton meters (μN-m). Predetermined sample length, deflection angle, and rate of loading provide accurate and reproducible test results. The instrument includes an onboard computer to automate testing including a high-resolution optical encoder and a non-contacting photo sensor. The onboard computer calculates and records testing data (including average, standard deviation, high/low, time, date, and a user-defined label), and converts stiffness readings to the appropriate user selected stiffness range.

Crease recovery may be measured using the methodology and test equipment detailed in one of several applicable standards including by way of example, and not limitation, ISO 4681, ISO 2313, ASTM D 1295, and AATCC66, all of which are known to those of skill in the art. Crease recovery may be measured using a popular instrument known as a Shirley crease recovery tester. This instrument comprises a circular dial which includes a clamp for holding the specimen. A knife edge and an index line for measuring the recovery angle are disposed directly under the center of the dial. Crease recovery is determined according to this measured recovery angle wherein a recovery angle of 0 degrees corresponds to no crease recovery and a recovery angle of 180 degrees corresponds to full crease recovery. Crease recovery depends on a variety of factors including, but not limited to, material construction, twist of yarn, pressure, and time as well as tensile, compressive, flexing, and torsional properties, as applicable.

For purposes of the present invention, opacity may be measured using different methods to determine the percentage of light blocked by the fabric when in front of the specified light source compared to the light emitted when not blocked by the fabric. ISO standard test method BS ISO 2471-Determination of opacity (Diffuse Reflectance method) is one method. Other methods directed to determining the percent of light which passes through the banner may also be used. See also, for example, American Association of Textile Chemists and Colorists Test Methods AATCC TM 148: Light Blocking Effect of Textiles: Photodetector Method and AATCC TMTM 203: Light Blocking Effect of Textiles: Spectrophotometric Method, both of which may be applicable to the present invention. Given the different opacity testing methods it should be understood that in any method of testing, if the opacity exceeds 80%, it is within the purview of the inventive concept disclosed herein. For the avoidance of any confusion, one specific testing method to determine opacity is defined as follows:
Fabric Opacity Testing Standard (FOTS-200L)

### Objective

To determine the opacity a fabric sample by measuring the amount of light passing through the fabric under controlled illumination of 200 lux.

### Equipment and Materials

1. 200 Lux Light Source: Light source capable of providing a consistent illumination of 200 lux.

2. Lux Meter: To measure the illuminance level before and after light passes through the fabric.

3. Light Tunnel: Enclosure to direct light from the light source to the fabric, minimizing external light interference and ensuring uniform light distribution. The tunnel is ideally cylindrical but can be square and should have a non-reflective interior. The dimensions of the light tunnel are dictated by the distance which the light source must be maintained from the fabric and the size of the fabric samples to be tested. It is anticipated that the light source will be positioned 24 to 36 inches from the fabric, so the tunnel should be at least 36 inches in length. A good fabric sample size is in the range of 12-14 inches so the outer walls of the tunnel should be dimensioned accordingly to be within the outer borders of the sample.

4. Fabric Holder: A frame or stand to securely hold fabric sample in place at the end of the tunnel during testing, ensuring no light leakage around the edges between the light tunnel and the fabric.

5. Standardized Background: A non-reflective, matte black background placed behind the fabric and lux meter testing location during testing, minimizing reflection and light interference.

6. Control Fabric: Fabric with a known opacity level close to the 85% threshold for calibration purposes.

### Sample Preparation

1. Conditioning: Condition fabric samples at approximately 21° C. (70° F.) and 65% RH for 24 hours before testing.

2. Sizing: Cut fabric sample to a uniform size, ensuring it is larger than the measurement area of the fabric tunnel.

### Calibration and Setup

1. Lux Meter and Light Source: Calibrate and position the light source to achieve a stable illuminance of 200 lux across the full area in which the fabric will be placed at the fabric's location at the end of the tunnel. Use the lux meter to verify this level.

2. Light Source Characteristics: The intensity and spread of the light source play an important role. A light source with a wide beam spread might require being placed closer to the fabric to achieve the desired illuminance level uniformly across the sample. Conversely, a more focused or intense light source might need to be placed further away to avoid uneven illumination.

3. Desired Illuminance (200 lux): The specific illuminance level of 200 lux needs to be maintained consistently across the fabric's surface. This requires adjusting the distance of the light source to the fabric to where the light evenly distributes across the entire sample.

4. Light Tunnel Setup: Position the light source within the tunnel, 24 to 36 inches from the fabric to achieve 200 lux luminescence across the entire fabric surface. Position the fabric at the end of the light tunnel and the lux meter on the opposite side of the fabric from the light source at approximately 8 inches.

5. Distance Adjustment: Adjust the distance between the light source and the fabric holder to where preliminary tests have shown uniform illumination of 200 lux across the testing area. As a starting point, positioning the light source approximately 24 to 36 inches (61 to 91.4 cm) from the fabric sample to provide a good balance between achieving the desired illuminance level and ensuring uniform light distribution across the fabric's surface. This recommendation assumes a standard light source without highly specialized optics. To determine the exact distance for your specific setup, consider the following procedure:
a) Measurement: Use the lux meter to measure the illuminance at the center and edges of the area that corresponds to the size of your fabric samples.
b) Adjustment: If the illuminance is too high or too low, or if there is significant variability between the center and edges, adjust the distance of the light source accordingly. Move the light source closer if the light is not sufficient or further away if the light is too intense or uneven.
c) Iteration: Repeat the measurement and adjustment process until you achieve a uniform 200 lux across the entire area of interest.
d) Uniform Coverage: The goal is to ensure that the entire fabric sample is evenly illuminated. Pay particular attention to maintaining uniform light distribution to avoid hotspots or areas of shadow.
e) Use of Light Modifiers: Depending on your light source, you may benefit from using diffusers, reflectors, or other light modifiers to achieve a more even distribution of light across the fabric sample.
f) This approach allows for flexibility in your testing setup and can be adapted to different types of light sources.

6. Control Fabric Test: Conduct a preliminary test using the control fabric to validate the accuracy of the light source and measurement setup.

### Testing Procedure

1. Environment Preparation: Ensure the testing room is darkened, with only the 200-lux light source active. Verify no other light sources are affecting the testing area.

2. Fabric Mounting: Secure a fabric sample in the fabric holder, ensuring complete coverage of the opening and no stretching of the fabric.

3. Illuminance Measurement:
1. Measure the illuminance (lux) 8 inches behind the fabric sample.
2. Record the value and calculate the fabric's opacity percentage using the formula:

Opacity %=(1−Measured Lux 200)×100 Opacity %=(1−200Measured Lux)×100

Repeat Measurements: Conduct the measurement three times for each fabric sample to ensure consistency and calculate the average opacity percentage.

For woven fabrics, opacity, and its opposite measure visible transmittance, may both be related to cover factor as well as the size of the yarn used, and picks per unit length. As those skilled in the art will recognize, fabrics with more open weaves (lower picks per unit length value) and thus lower cover factor values accordingly may allow greater light to pass through resulting in higher visible transmittance values and generally lower opacity values. Conversely, fabrics with tighter weaves (higher picks per unit length values) and thus higher cover factor values allow less light to pass through, resulting in a lower visible transmittance values and generally higher opacity values. The opacity of nonwoven fabrics similarly depends on a variety of factors including most notably the density and method of entangling of the comprising fibers. Note that whether a fabric is woven, knit, nonwoven, a film or other construction, or any combination thereof in whole or in part, opacity is also affected by other factors such as pigmentation and thickness of the fabric or some of its components, materials, or layers, as well as coatings, films or treatments applied thereto. For purposes of the present invention, wherein higher fidelity printed messages and images are desired to be printed on one and preferably both sides of the banner 10 for concurrent display, it is therefore desirable to increase opacity and prevent show-through by using one or more higher opacity layers.

Improved dimensional stability of fabric 10 may accordingly be achieved in accordance with the present invention wherein rollable fabric 10 has a bending length greater than approximately 6.5 cm as measured in at least one direction which is aligned with and substantially parallel to the axis of rotation 24 of spool 16. This may be the X or M direction depending on the orientation of fabric 10. As shown in FIG. 1, wherein rollable fabric 10 is oriented horizontally, dimensional stability will therefore be achieved wherein fabric 10 has a bending length greater than 6.5 cm as measured in the X direction and less than approximately 14 cm as measured in the M direction. If oriented vertically, dimensional stability may be achieved wherein fabric 10 has a bending length greater than approximately 6.5 cm as measured in the M direction and less than approximately 14 cm as measured in the X direction. Dimensional stability will also be achieved wherein the X direction to M direction bending length ratio is greater than approximately 1.3 to 1. Such dimensional stability may also be achieved where the rollable fabric 10 has an areal density less than approximately 650 grams per square meter, and/or a flexural rigidity value greater than approximately 637 μN-m or 6.5 TABER Stiffness Units, in each case, such flexural rigidity as measured in at least one direction (typically but not necessarily the cross-machine or filling direction X, depending on the orientation of the rollable fabric). Such dimensional stability may also be achieved wherein rollable banner 10 has a flexural rigidity ratio of stiffness in first and second directions (e.g., the X and M directions) greater than 1.3 to 1. Dimensional stability may also be provided or enhanced wherein the rollable fabric a crease recovery greater than approximately 90 degrees as measured in at least one direction.

Accordingly, by way of example, and not limitation, such dimensional stability may be achieved in accordance with the present invention where the rollable fabric has a flexural rigidity value greater than approximately 637 μN-m or 6.5 TABER Stiffness Units in the X direction and a flexural rigidity value less than approximately 2940 μN-m or 30 TABER Stiffness Units in the M direction. In keeping with the invention, it is understood that the X and M directions referenced herein are relative to the spool regardless of the orientation of the spool to its surroundings (i.e., whether the fabric deploys horizontally, vertically, or otherwise. In further keeping with the invention, it is understood that changes to the spool size and structure, the torque applied to the spool for deployment and/or retraction, as well as the fabric structure, will affect the foregoing flexural rigidity estimates. Dimensional stability may further be achieved where the rollable fabric has an X direction to M direction flexural rigidity ratio greater than approximately 1.3 to 1 and/or a ratio of flexural rigidity to areal density, greater than 0.019 to 1 of TABER Stiffness Units to grams per square meter. Achieving these ratios may be accomplished in different ways, and by example only, fabric 10 may optionally include one or more X-direction stiffening fibers.

An additional fabric property that is important for consideration is thickness of the fabric. While maintaining control of the other fabric properties mentioned, a thinner fabric will typically be preferred. Thinner fabrics allow longer lengths of the fabric to be put on a roll and also may function better as they are rolled, unrolled, and displayed. Also in keeping with the invention, when printing on the rollable fabric 10 is intended to effectively impart communications, a form and structure is desirable which provides a sufficiently smooth and continuous display surface 25 having sufficient opacity, typically greater than 70 percent and preferably but not necessarily greater than approximately 80 percent, or alternatively, sufficiently limited visible transmittance, for messages and/or messaging components including text, graphics, images, advertisements, marketing, wayfinding, and like communications or communication components to be effectively placed thereon. The foregoing includes but is not limited to, printing, such as by way of example and not limitation, high fidelity printing, to display such messages on display surface 25, and in a preferred but not required embodiment, concurrently on opposing display surface 26 as well. The form and structure further imparts dimensional stability with sufficiently reduced fabric distortions and with sufficiently low weight, and sufficient flexural rigidity to collectively reduce unevenness and tension variances as necessary to promote smooth unrolling and rolling of the fabric 10, which is particularly useful when the fabric is deployed as a banner from a retractable banner assembly and only supported at its ends 14 and 18. It further enables fabric 10 to be deployed with display surface 25 oriented for enhanced viewing, namely substantially flat and thus in a preferred but not required embodiment, substantially normal to a walking surface 27.

It is also beneficial that fabric 10 has adequate crease recovery so that when subjected to different bending and creasing forces while in use, the fabric can recover to its intended flat condition with minimal creasing. In the case of the present invention, adequate crease recovery in at least one direction, typically at least 90 percent, is required to ensure that bending forces on the fabric 10 do not result in one or more creases that would undermine the aesthetic presentation of the fabric specifically including content printed or otherwise displayed on one or both sides thereof, or interfere with the ability of the banner to smoothly retract and deploy for its intended use, application, and lifetime.

As those skilled in the art will recognize, opacity and flexural rigidity are typically increased in fabrics by using more tightly woven and/or thicker materials to reduce transmission of light and resist bending, as applicable, in each case adding material and thus weight, namely areal density. Such increase in areal density, however, may in fact undermine the goal of increasing dimensional stability and increase fabric banner distortions and unevenness of its surface as referenced above. Accordingly, while thicker heavier fabrics may tend to be stiffer and more opaque, these parameters along with aerial density and crease recovery must all be properly aligned to achieve the dual objectives of sufficient opacity for printing, particularly higher fidelity printing on one and preferably, but not necessarily, dual and opposing display surfaces 25 of rollable fabric 10 as well as overall dimensional stability to sufficiently reduce fabric distortions to promote smooth unrolling and thus extension, deployment, and rolling and thus retraction.

In keeping with the invention, rollable fabric 10 will also benefit from but is not required to have low texture, in whole or in part, on its external visible surfaces 25 and 26 as necessary to promote smooth rolling and unrolling as well as to impart higher print quality. In a preferred but not required embodiment wherein higher fidelity printing is applied on one or both surfaces 25 and 26, printing may have sufficient print quality where such surface texture is less than approximately 10 micrometers as measured using a suitable contact or non-contact-profilometer. It is recognized, however, that the foregoing range may vary accordingly depending on the structure, method of manufacture, and implementation of fabric 10, as well as the applicable printing process used, including by way of example and not limitation, digital printing, ultraviolet (UV) printing, screen printing, sublimation printing, heat transfer printing, block printing, rotary printing, discharge printing, foil printing, pigment printing, direct-to-garment (DTG) printing, transfer printing, reactive printing, water-based printing, flock printing, plastisol printing, foaming printing, burnout printing, embossed printing, resist printing, and photographic printing, and the like. Still further, depending on the use, rollable fabric 10 should not have openings or have sufficiently few and sufficiently small openings in display surfaces 25 and 26, generally correlating to a higher cover factor value on the order of greater than approximately 70% and preferably, but not necessarily, greater than 80%, to provide the desired smooth and continuous display surfaces 25 and 26 to enable printing thereon, including in a preferred but not required embodiment, higher fidelity printing. However, in some use cases such as in in wind, a correct openness factor to balance aesthetics with allowing air to pass through will be appropriate. In this situation the aesthetics may be acceptably compromised in favor of the overall performance of the banner in the wind. Low texture and a low openness factor will also generally improve the aesthetics of high-fidelity printing on rollable banner 10 and may therefore be desirable in many situations but these properties are optional to the invention herein, depending on the use case.

It should be noted that the above referenced preferred areal density and stiffness/flexural rigidity values are impacted by a variety of factors including the banner composition including, the type, length, size, weight, and orientation of fibers used, whether the fibers are woven, non-woven, or knit, the number of layers, and the manufacturing process utilized, including whether one or more such layers are coated, laminated, or even embedded in a material. In keeping with the invention, fabric 10 thus structurally comprises at least one rollable layer which in one preferred, but not required, embodiment, further comprises a plurality of fibers and which layer provides the required sufficiently smooth and continuous display surface for the aforementioned messages to be printed thereon. The at least one rollable layer further imparts the required dimensional stability with sufficiently reduced banner distortions and thus unevenness to promote the required smooth unrolling and rolling of fabric 10, and to enable its deployment with display surface 25 oriented substantially flat, and in one preferred, but not required embodiment, substantially normal to walking surface 27 as shown in assembly 12 of FIG. 1.

It is further understood that the aforementioned preferred values for areal density, flexural rigidity, crease recovery, and opacity are all beneficial to achieving the dual objectives of providing at least one sufficiently smooth and continuous display surface to impart aesthetically pleasing communications, including higher fidelity printed messages on one or both sides of the fabric 10 and to further impart the required dimensional stability to properly orient the display surface for enhanced viewing and enable the fabric to smoothly deploy and retract, particularly across extended distances greater than narrow entryways and the like, when implemented in an assembly 12. Changes to these objectives will correspondingly result in different preferred values. By way of example only and not limitation, in the case of retail check-out aisles and the like, where the fabric or banner if incorporated in a retractable banner assembly, may typically span a shorter distance than described above, dimensional stability may be less a factor than the provision of a smooth and continuous display surface. In such a case, some reduced or compromised fabric property values of the foregoing may be acceptable including bending length, flexural rigidity, and aerial density.

In alternative, but not required additional embodiments of fabric 10, one or more supplemental rollable layers may be provided and positioned on the first layer, wherein the first layer includes a plurality of fibers, and the one or more supplemental layers function to stabilize the same in whole or in part. In these alternative embodiments, the first and one or more supplemental layers together provide the required sufficiently smooth and continuous display and together impart the required dimensional stability with sufficiently reduced banner distortions to promote the required smooth unrolling and rolling of fabric 10, and to enable its deployment with display surface 25 oriented substantially flat. It is contemplated that, yet additional rollable layers may be provided to achieve the stabilization of the plurality of fibers and to collectively provide the required sufficiently smooth and continuous display surface and further impart the required dimensional stability, opacity, and flat orientation of display surface 25 on deployment of fabric 10.

In keeping with the invention, the flexural rigidity profile of fabric 10 may be isotropic (i.e., uniform in both the M direction and X direction) or anisotropic (i.e., non-uniform). If isotropic, the limit of flexural rigidity in both directions (the direction of unrolling designated generally by reference letter M and the direction of its center axis of rotation 24 designated generally by reference letter X) is determined in the first instance by the requirement that the fabric be flexible enough to roll up. Accordingly, there is a flexural rigidity limitation which depends in part on the diameter that the fabric is being rolled to but in many cases will be less than approximately 2,940 μN-m in the M direction such that the fabric is not prevented from easily rolling and unrolling. The dimensional stability of the banner and its ability to counteract distortions when deployed may also benefit from anisotropic stiffness according to the present invention such that it has greater stiffness in at least one direction generally and in one preferred but not required embodiment shown herein, greater stiffness in the direction X than the direction M, specifically. As shown, in this embodiment, direction X is substantially parallel to the center axis of rotation 24 of spool 16 and conversely substantially perpendicular to the direction of unrolling M of banner 10, regardless of how the banner is oriented (e.g., substantially horizontally as shown in FIG. 1, vertically, or otherwise). While there is presently understood to be no upper limit to the amount of stiffness in the X or cross-machine direction, it is understood that the banner functionality will benefit from being stiffer in the X direction and preferably, but not necessarily, at least 1.3 times stiffer than the M direction.

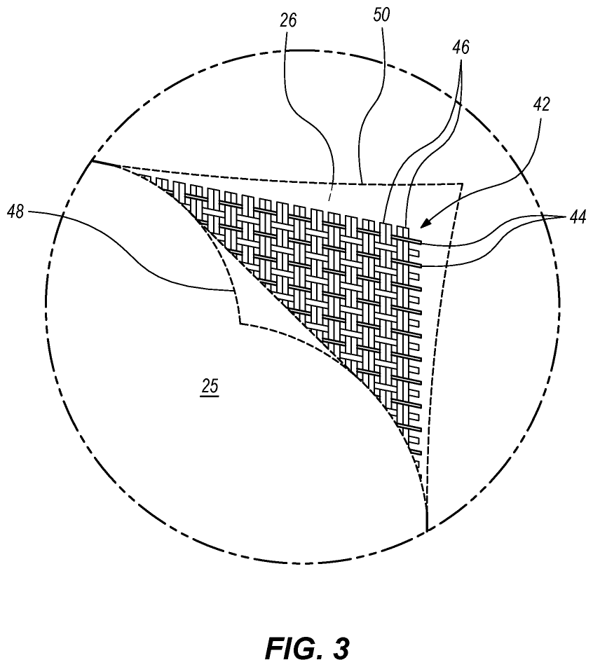

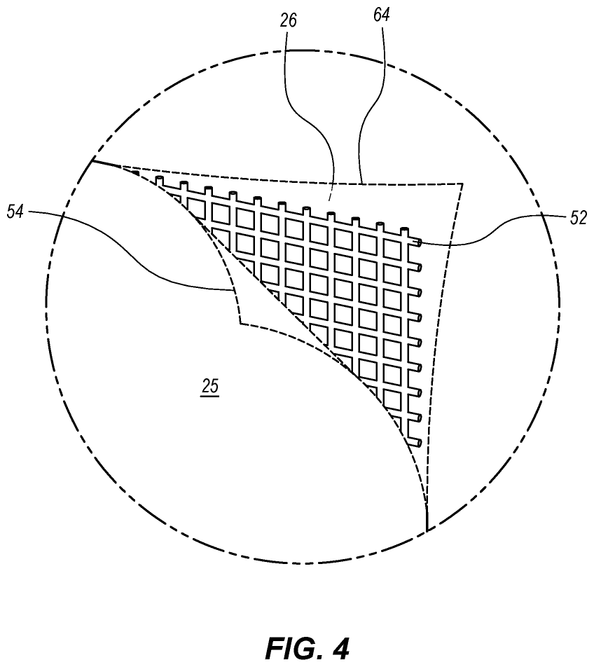

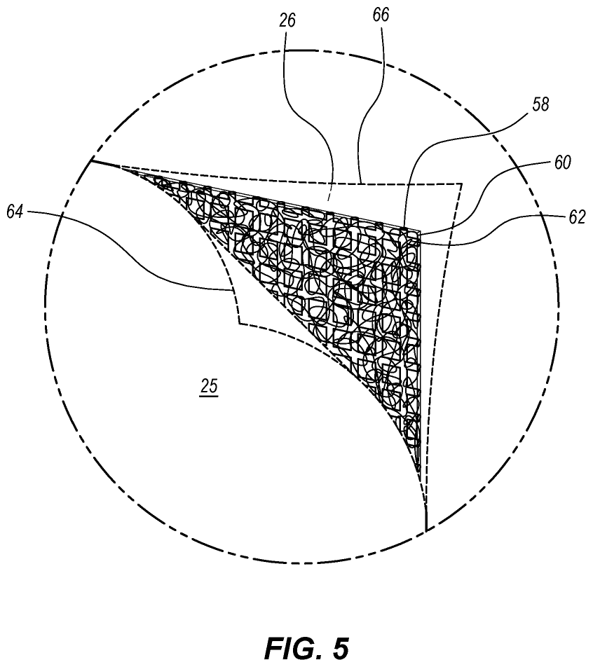

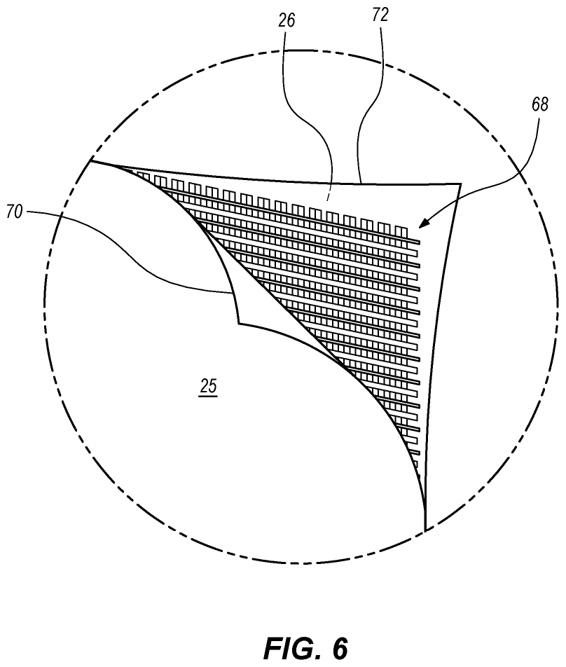

Turning now to FIGS. 3-6 of the drawings, there is disclosed various banner structures according to the present invention including a one-directional stiffening fiber substrate wherein the stiffening fiber may be a monofilament, (FIG. 3), an extruded substrate (FIG. 4), a substrate assembly comprising an extruded scrim and non-woven material (FIG. 5), and a laid substrate (FIG. 6). As shown, in each case, the substrate or substrate assembly, as applicable, may be, but is not required to be, coated or laminated in whole or in part with one or more layers deposited on either or both sides thereof as necessary for the banner to (a) have sufficiently low texture, and adequate cover factor and opacity on its external surfaces to achieve the required sufficiently smooth and continuous display surface for messages and/or messaging components to be effectively placed on one or both sides thereof, and (b) achieve sufficiently low arial density, and a sufficient flexural rigidity profile for the intended application, including sufficient bending length and sufficient crease recovery values, to impart the required dimensional stability to reduce unevenness and tension variances as necessary for the display surface to be oriented substantially flat on deployment for enhanced viewing and to promote smooth unrolling and rolling of the banner.

As those skilled in the art will recognize, many different types of substrates may be used in fabrics, and it is understood that any substrate or substrate assembly that achieves the dual objectives of the present invention will be acceptable. Namely, the structure must provide a rollable fabric having improved physical characteristics, including sufficient dimensional stability, to sufficiently reduce unevenness of the fabric to promote the smooth rolling and unrolling of the fabric whereby to promote deployment of the fabric in an aesthetically pleasing manner with sufficiently reduced distortions such as sagging, rippling, buckling, drooping, curling, and like unevenness to effectively impart communications placed thereon. The monofilament, extruded, non-woven, and laid, substrate and substrate assembly structures described in further detail below are exemplary of but not limitations of such suitable fabric substrates.

Referring to FIG. 3 of the drawings, a monofilament substrate typically comprises a plurality of monofilament filaments, generally manufactured through an extrusion process and having, if desired, a uniform cross section, diameter, and thickness. Such monofilament fibers may be woven, knitted, or otherwise interlaced in a suitable manner with each other or with other types of fibers in the substrate. Monofilament substrates are often used in applications where a high level of strength is required. In the context of the current invention however, a monofilament substrate is not used for strength but rather to increase stiffness in the M direction. The monofilament fibers to be used are of proper diameter and material to impart greater stiffness in the X direction than fibers used in the M direction. Through alignment of the monofilament fibers in the X direction and use of other less stiff fibers in the M direction, anisotropic stiffness is achieved with greater stiffness in the X direction. As noted above, continuous multi-filament and mono-filament yarns can be extruded from polymers such as polyester, nylon, and a variety of other materials. These yarns can be used either in continuous filament form or they may be segmented into staple fibers or defined lengths. In the case of a single thread, it may be warp or weft knitted using a conventional interlacing process or woven into fabric using warp (machine direction) and weft (cross-machine direction) yarns. It should be noted that for the purposes of the present invention, it is not required that that X direction fiber members be a monofilament. Any suitable fiber or fiber structure used in the X direction that imparts greater stiffness in the X direction than the M direction will suffice. It should also be noted that monofilament or other stiffening fibers can be used in the M direction as well if it is desired to increase stiffness in the M direction as well which may also positively contribute to the dimensional stability. As stated above, and it is a key point of the invention herein, stiffness in the M direction is limited to that which will not prevent the rolling of the fabric in the particular situation in which it is being used.

Still referring to FIG. 3, a monofilament substrate indicated generally by reference numeral 42 may be used in accordance with the present invention. As shown, substrate 42 includes a plurality of extruded filaments 44 each having, if desired, but not required, a uniform cross section, diameter, and thickness that may be woven, knitted, or otherwise interlaced in a suitable manner with fibers 46. Monofilament substrate 42 resists bending in the X direction but allows flexibility in the M direction. Monofilament substrate 42 may be coated or laminated, with one or more layers 48 and 50 as shown, to achieve the required smooth and continuous printing and display surface and impart the required dimensional stability. The specifics of the referenced monofilament design, including diameter and spacing, and stiffness, can be adjusted according to the desired mechanical properties of the applicable fabric keeping in mind that the bending stiffness will typically increase as the monofilament diameter increases. There is a balance of smoothness of finish, tending toward small monofilaments, and X direction rigidity, tending toward larger monofilaments, that must be achieved for each particular application. In the exemplary, but not required embodiment shown, the extruded elements 44 have a diameter in the range 0.20-0.6 mm, picks per unit length in the range 5-60 PPI, and again the rollable fabric 10 has an areal density less than approximately 650 grams per square meter, stiffness greater than approximately 50 μN-m, a bending length greater than approximately 10 cm as measured in the cross-machine direction, crease recovery to at least 90 degrees, and a printable surface with opacity preferably but not necessarily greater than approximately 80%. As indicated more, less, or no layers of any suitable material, including but not limited to film, may be laminated to either or both sides of substrate 42. Substrate 42 may similarly be coated in whole or in part with any suitable material including, but not limited to, a polymer, alone or in combination with the provision of one or more laminated layers. In fact, any or all the individual filaments and/or woven fibers 44 and 46 may be similarly coated in whole or in part before weaving or knitting the same into substrate 42.

An extruded substrate as shown in FIG. 4 is similarly made through an extrusion process and typically, but not necessarily, fused at its cross points. In this process, molten material which may comprise a variety of different suitable materials including polymers such as polyester, nylon, and polypropylene, may be forced through a die to create a continuous sheet of material. Some modern machinery can extrude and fuse the elements of the substrate in a single near simultaneous process. The resulting substrate may be uniform and/or have consistent thickness throughout, except for the connection points which, if fused as indicated above, will tend to be thicker, depending on the manufacturing process and objectives. In order to create anisotropic stiffness for purposes of the current invention the extruded scrim can be stretched in the M direction. As the scrim stretches, the M direction members become thinner and therefore less stiff. Extruded substrates are commonly used as base layers for laminating or coating with additional materials and are useable to achieve the desired objectives of the present invention.

Still referring to FIG. 4, a second preferred, but not required, embodiment of rollable fabric 10 is shown which may be used to achieve the required smooth and continuous display surface and to impart the required dimensional stability of the fabric in accordance with the present invention. In this embodiment, there is provided an extruded substrate or center layer 52. One of the advantages of using extruded material for banner 10 is that it can be engineered to have specific properties of weight and stiffness but also UV resistance or fire retardancy, depending on the needs of the application. Additionally, the extrusion process can be more efficient and cost-effective than producing individual fibers. Again, in keeping with the invention, rollable fabric 10 in the embodiment shown in FIG. 4 has an areal density less than approximately 650 grams per square meter, stiffness greater than approximately 50 μN-m, a bending length greater than approximately 10 cm as measured in the cross-machine direction, crease recovery to at least 90 degrees, and a printable surface with opacity preferably but not necessarily greater than approximately 80%. As in the case of the monofilament substrate 42 of FIG. 3, substrate 52 may be optionally laminated and/or coated with one or more layers 54 and/or 56, comprising any suitable material including film and polymer which may be bonded through the substrate's interstices, as necessary to achieve the objectives of the present invention.

A non-woven layer as shown in FIG. 5 can be used on one or both sides of a scrim or other stiffening structure of any type to cover or fill interstices and help in creating a smooth, flat outer surface that is suitable for printing to present messaging in an aesthetically pleasing manner. Similarly, the scrim or other stiffening elements can be imbedded in or entangled with the non-woven. Non-woven materials are fabrics typically created by bonding fibers together without weaving or knitting them into a fabric. Instead of being a woven or knit like traditional textiles, non-woven fabrics are created through a process of engaging such as by way of example but not limitation, depending on the specific non-woven process utilized, entangling, or bonding fibers, either mechanically or chemically, to create a web of interrelated and typically interlocking fibers. There are several different methods for creating non-woven materials, but all involve some form of fiber engagement with the most common methods being spun bonding, melt blowing, needle punching, and chemical bonding. As those skilled in the art will recognize, spun bonding involves extruding filaments of polymer through spinnerets, which are then laid down onto a conveyor belt to form a web of fibers. The fibers are then bonded together using heat or pressure to create a non-woven fabric. Melt blowing involves extruding polymer through a die to create fine fibers, which are then blown by hot air onto a conveyor belt to create a web of fibers. The fibers are then bonded together using heat and/or pressure. Still further, needle punching involves pushing fibers through a web of material using a series of needles, which entangles the fibers and creates a non-woven fabric. Finally, chemical bonding involves applying a chemical adhesive to a web of fibers, which bonds them together to create a non-woven fabric. Non-woven materials are used in a wide range of applications as they have several advantages over traditional woven fabrics. They are often more durable, lightweight, and resistant to tearing. They are also generally less expensive to produce than woven fabrics. Additionally, a suitable nonwoven material with appropriate stiffness and areal density (not shown) can be used to impart the needed fabric properties for the current invention. The non-woven may but is not required to be coated or laminated to make the surface smoother and more printable.

Still referring to FIG. 5, there is shown an additional preferred, but not required, embodiment of rollable fabric 10 comprising a non-woven substrate assembly 58 including non-woven material 60 and extruded substrate 62. The non-woven 60 may be used in combination with any suitable monofilament, extruded, laid or other substrate possibly embedded or incased within the nonwoven material again as required by the application and functionality and as necessary to achieve the objectives of the present invention. Other strengthening or stiffening elements, such as by way of example and not limitation, a plurality of monofilaments, may also be embedded or inserted within the non-woven to create the needed stiffness profile. In the exemplary alternative embodiment shown in FIG. 5, an extruded substrate or center layer 62 is thus embedded within non-woven material 60 by bonding one or both sides of substrate 62 thereto using heat and/or chemical bonding. This process creates a sandwich-like structure, with the substrate 62 at the center and the non-woven material 60 encasing it on one or both sides. Again, the selection of substrate 62 as an extruded structure is for exemplary purposes only. It being understood that layer 62 could comprise any other suitable structure embedded or otherwise sandwiched, encasing or inserted within the non-woven material 60 including by way of example, and not limitation, a needled monofilament substrate.

The non-woven encasement provides several benefits to substrate assembly 58 including increased strength, durability, resistance to tearing and abrasion, and most importantly, it creates a more even surface and adds opacity across the interstices of the scrim. It also helps to prevent substrate 62 from stretching or distorting over time, which can lead to the banner 10 becoming less effective. Again, in keeping with the invention, banner 10 in the embodiment shown in FIG. 5 has an areal density less than approximately 650 grams per square meter, stiffness greater than approximately 50 μN-m, a bending length greater than approximately 10 cm as measured in the cross-machine direction, crease recovery to at least 90 degrees, and a printable surface with opacity preferably but not necessarily greater than approximately 80%. As in the case of the monofilament substrate 42 of FIG. 3, and extruded substrate 52 of FIG. 4, the non-woven substrate assembly 58 of FIG. 5 may similarly be optionally laminated and/or coated with one or more layers 64 and/or 66, comprising any suitable material including film and polymer to achieve the desired dimensional stability and impart aesthetically pleasing communications. In the context of the invention disclosed herein, a properly engineered non-woven substrate may possess the required properties to alone achieve the objectives of the present invention. If so engineered, the non-woven 60 may be used on its own without a coating or lamination or even a center layer or scrim 62. Laminations and coatings do however tend to enhance the printability of non-woven materials.

A laid substrate, as shown in FIG. 6, is made from laying or interlacing, as applicable, fibers or yarns that are typically disposed parallel to each other in a specific pattern. Laid substrates can be woven or non-woven and may be made from a variety of materials or combinations thereof including natural fibers, synthetic fibers, or a blend of the two, including polyester, nylon, and polypropylene. Laid substrates, depending on a number of factors, including threads per unit length, may also be less uniform and less strong than extruded substrates, but they offer more flexibility in terms of design and texture. For further context, a traditional substrate is typically, but not necessarily, made using a weaving technique known as a laid weave which involves crossing warp and weft threads over each other in a way that creates small, diamond-shaped holes in the fabric. These holes are what give the substrate its characteristic translucent, see-through appearance. In a laid substrate, the weft threads are dropped on top of or between warp layers, often with a rotating tool to create a grid-like pattern. Unlike a traditional substrate, a laid substrate does not have the small holes created by a leno weave. Instead, the open spaces in the fabric are created by the gaps between the parallel warp threads.

Still referring to FIG. 6, there is accordingly shown and described yet another preferred, but not required, embodiment of rollable fabric 10 comprising a laid substrate 68. Again, in keeping with the invention, rollable fabric 10 in the embodiment shown in FIG. 6 has an areal density less than approximately 650 grams per square meter, stiffness greater than approximately 50 μN-m, a bending length greater than approximately 10 cm as measured in the cross-machine direction, crease recovery to at least 90 degrees, and a printable surface with opacity preferably but not necessarily greater than approximately 80%. As in the case of the monofilament substrate 42 of FIG. 3, extruded substrate 52 of FIG. 4, and non-woven substrate assembly 58 of FIG. 5, laid substrate 68 of FIG. 6 may similarly be optionally laminated and/or coated with one or more layers 70 and/or 72, comprising any suitable material including film and polymer to achieve the desired dimensional stability and impart aesthetically pleasing communications.

In summary, each type of exemplary, but not limiting, substrate referenced above has its own unique characteristics and is suited to different applications depending on the desired properties of the final product as required for the applicable use and functionality. The types of substrates discussed herein provide examples of how a multiple component fabric system can work to achieve the objects of the current invention. Generally, the substrate will provide most of the stiffness and dimensional stability, and a secondary layer, film or coating flattens and smooths the surface texture and makes the surface printable. Any substrate, scrim or other component which provides the desired stiffness in at least one direction is contemplated by this invention. All of the different substrate types disclosed herein may be coated and/or laminated to achieve the desired properties namely, sufficient flexural rigidity, crease recovery, and opacity to enable the smooth extension, deployment, and retraction of the banner and to further enable the effective delivery of aesthetically pleasing communications. While it is likely that both sides of the applicable substrate will be coated or laminated to facilitate the foregoing, including two-sided printing, such as higher fidelity printing, it is possible depending on the application that only one side, or even a portion thereof, will require such coating or laminating. It should be noted that one sided printing that yields lower weight and sufficiently high stiffness still achieves the objective of enabling smooth extension, deployment, and retraction of fabric 10 without fabric surface deviations (i.e., unevenness) so that the banner will be oriented sufficiently flat with reduced or sufficiently eliminated unevenness upon deployment to effectively display graphics.

Again, it is understood that rollable fabric 10 disclosed herein is not limited to these forms and methods of construction and may for example be formed from one or more solid sheets or films which may be formed through an extrusion or other suitable process provided the resulting banner has sufficient stiffness and opacity and sufficiently low areal density to achieve the desired objectives of providing a sufficiently smooth and continuous display surface for messages to be effectively displayed therefrom and increasing dimensional stability to enable smooth unrolling, deployment, and rolling of the banner.

It should further be noted that extruded substrates of the type described herein tend to have large interstices, so coating alone might not result in the desired continuous surface and in such case, lamination may be a more suitable finishing process whether alone or in combination with coating. As indicated above, a nonwoven may be used as a layer over a substrate to cover the interstices and create a smoother surface. It should further be noted that some nonwovens are in fact printable, so a substrate covered by a thin layer of nonwoven material could be a suitable finished product for the banner depending on the resulting stiffness and opacity. It is also possible that a film could be laminated over the nonwoven if desirable to provide a different outside surface (e.g., texture, color, porosity, opacity, etc.) for printing. Still further, the nonwoven could also be formed around the substrate, including integrally formed, further including its interstices, so that the substrate is essentially embedded within the structure of the nonwoven as referenced herein. It would then be possible to print directly on the nonwoven or any laminated or coated layer applied thereto. Lastly, monofilament fibers may be inserted into the non-woven through needling or other process, which involves mechanically punching the monofilament fibers into the nonwoven fabric using barbed needles or other suitable punching elements. The result is a composite material that combines the properties of the monofilament fiber and the nonwoven fabric wherein the monofilament fibers structurally hold the nonwoven in place, add opacity, and create a more even surface which may similarly be coated or have one or more laminate layers applied thereto on either or both sides of the substrate.

While exemplary embodiments of the invention have been illustrated and described, it is not intended that these embodiments illustrate and describe all possible forms of the invention, and such embodiments are not intended to limit the scope or the application or claims in any way. Rather, the words used in the specification are words of description rather than limitation, and it is understood that various changes may be made, and equivalent structures, features, and functions may be provided, without departing from the spirit and scope of the invention and defined by the following claims.

1. A retractable banner assembly, comprising:
a rotatable elongate mounting rod; and
a rollable banner affixable directly or indirectly to the mounting rod, with a bending length greater than 6.5 cm as measured in at least one direction.

2. The retractable banner assembly of claim 1, wherein the banner has a crease recovery greater than 90 degrees as measured in at least one direction.

3. The retractable banner assembly of claim 1, wherein the banner has an opacity value greater than 80 percent.

4. The retractable banner assembly of claim 1, wherein the banner comprises a plurality of X-direction stiffening fibers.

5. The retractable banner assembly of claim 1, wherein the at least one direction is a X direction, and the rollable banner has a bending length less than 14 cm as measured in a M direction.

6. The retractable banner assembly of claim 1, wherein the banner has at least one display surface that is sufficiently smooth and continuous for messages to be printed thereon.

7. The retractable banner assembly of claim 1, wherein the banner has a X direction to M direction bending length ratio greater than 1.3 to 1.

8. A retractable banner assembly, comprising:
a rotatable elongate mounting rod; and
a rollable banner affixable directly or indirectly to the mounting rod and having an areal density less than 650 grams per square meter and a flexural rigidity value greater than 6.5 TABER Stiffness Units as measured in at least one direction.

9. The retractable banner assembly of claim 8, wherein the banner has a crease recovery greater than 90 degrees as measured in at least one direction.

10. The retractable banner assembly of claim 8, wherein the banner has an opacity value greater than 80 percent.

11. The retractable banner assembly of claim 8, wherein the banner comprises a plurality of X-direction stiffening fibers.

12. The retractable banner assembly of claim 8, wherein the banner has a X direction to M direction flexural rigidity ratio greater than 1.3 to 1.

13. The retractable banner assembly of claim 8, wherein the banner has at least one display surface that is sufficiently smooth and continuous for messages to be printed thereon.

14. A retractable banner assembly, comprising:
a rotatable elongate mounting rod; and
a rollable banner affixable directly or indirectly to the mounting rod and having an areal density less than 650 grams per square meter and a flexural rigidity value greater than 637 μN-m as measured in at least one direction.

15. The retractable banner assembly of claim 14, wherein the banner has a crease recovery greater than 90 degrees in at least one direction.

16. The retractable banner assembly of claim 14, wherein the banner has an opacity value greater than 80 percent.

17. The retractable banner assembly of claim 14, wherein the banner comprises a plurality of X-direction stiffening fibers.

18. The retractable banner assembly of claim 14, wherein the banner has a X direction to M direction flexural rigidity ratio greater than 1.3 to 1.

19. The retractable banner assembly of claim 14, wherein the banner has at least one display surface that is sufficiently smooth and continuous for messages to be printed thereon.

20. A retractable banner assembly, comprising:
a rotatable elongate mounting rod; and
a rollable banner affixable directly or indirectly to the mounting rod, with a ratio of flexural rigidity as measured in at least one direction, to areal density, greater than 0.019 TABER Stiffness Units/grams per square meter.

21. The retractable banner assembly of claim 20, wherein the banner comprises a plurality of X-direction stiffening fibers.

22. The retractable banner assembly of claim 20, wherein the banner has a X direction to M direction flexural rigidity ratio greater than 1.3 to 1.

23. The retractable banner assembly of claim 20, wherein the banner has at least one display surface that is sufficiently smooth and continuous for messages to be printed thereon.
